(19) United States
(12) Patent Application Publication
(10) Pub. No.: US 2024/0296330 A1
(43) Pub. Date: Sep. 5, 2024

(54) NEURAL NETWORKS FOR EMBEDDED DEVICES

(71) Applicant: Tesla, Inc., Austin, TX (US)

(72) Inventors: Forrest Nelson Iandola, San Jose, CA (US); Harsimran Singh Sidhu, Fremont, CA (US); Yiqi Hou, Berkeley, CA (US)

(21) Appl. No.: 18/664,035

(22) Filed: May 14, 2024

Related U.S. Application Data
(63) Continuation of application No. 18/156,628, filed on Jan. 19, 2023, now Pat. No. 11,983,630.
Application No. 18/156,628 is a continuation of application No. 16/559,483, filed on Sep. 3, 2019, now Pat. No. 11,562,231.
(60) Provisional application No. 62/726,396, filed on Sep. 3, 2018.

(51) Int. Cl. G06N 3/08; G06F 7/575

(52) U.S. Cl. CPC G06N 3/08; G06F 7/575

(57) ABSTRACT

A neural network architecture is used that reduces the processing load of implementing the neural network. This network architecture may thus be used for reduced-bit processing devices. The architecture may limit the number of bits used for processing and reduce processing to prevent data overflow at individual calculations of the neural network. To implement this architecture, the number of bits used to represent inputs at levels of the network and the related filter masks may also be modified to ensure the number of bits of the output does not overflow the resulting capacity of the reduced-bit processor. To additionally reduce the load for such a network, the network may implement a “starconv” structure that permits the incorporation of nearby nodes in a layer to balance processing requirements and permit the network to learn from context of other nodes.

### CROSS-REFERENCE TO RELATED APPLICATIONS

This application is a continuation of U.S. patent application Ser. No. 18/156,628 filed on Jan. 19, 2023, which is a continuation of U.S. patent application Ser. No. 16/559,483, filed on Sep. 3, 2019, which claims the benefit of U.S. Provisional Patent Application No. 62/726,396, filed Sep. 3, 2018, all of which are hereby incorporated by reference in their entirety for all purposes.

### GOVERNMENT SUPPORT CLAUSE

This invention was made with government support under SBIR Phase II Grant Award No. 1758546 awarded by the National Science Foundation. The government has certain rights to the invention.

### BACKGROUND

This disclosure generally relates to the deployment of deep neural networks for embedded or internet-of-things (IOT) devices.

Neural networks are often used to perform various tasks, particularly for image analysis, such as object recognition, facial recognition, or segmentation. In more typical implementations, such networks are implemented on relatively complex processors, which may include operations with a high level of precision and with significant bit-length, such as 32-bit floating point operations to multiply and sum data at various layers of a neural network. These processors may be too complex or expensive for use in inexpensive devices, such as IOT devices that may include inexpensive processors having a more limited bit-length, preventing such IOT devices from effectively implementing neural networks. In addition to reduced-bit processing, these devices may also implement reduced-bit storage, further limiting the working capacity of such devices to successfully implement neural network structures.

### SUMMARY

A neural network architecture is used that reduces the processing load of implementing the neural network. This network architecture may thus be used for reduced-bit processing devices. The architecture may limit the number of bits used for processing and reduce processing to prevent data overflow at individual calculations of the neural network. To implement this architecture, the number of bits used to represent inputs at levels of the network and the related filter masks may also be modified to ensure the number of bits of the output does not overflow the resulting capacity of the reduced-bit processor. To additionally reduce the load for such a network, the network may implement a “starconv” structure that permits the incorporation of nearby nodes in a layer to balance processing requirements and permit the network to learn from context of other nodes.

### BRIEF DESCRIPTION OF THE DRAWINGS

FIG. 1 illustrates the star-shaped convolution filter (star-conv), according to one embodiment.

FIG. 2 illustrates the star-shuffle neural network block, according to one embodiment.

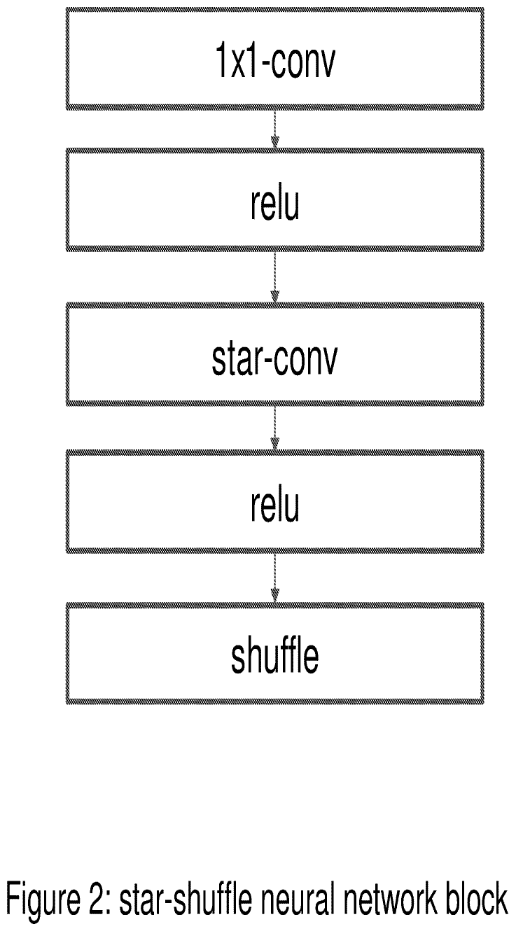

FIG. 3 illustrates an example StarNet deep neural network architecture, according to one embodiment.

FIG. 4 illustrates example equations for quantization and dequantization, according to one embodiment.

FIG. 5 illustrates example equations for determining quantization parameters, according to one embodiment.

FIG. 6 illustrates example equations for adjacent quantization equations, according to one embodiment.

FIG. 7 illustrates an example process for generating a neural network structure including input layers and filters, according to one embodiment.

The figures depict various embodiments of the present disclosure for purposes of illustration only. One skilled in the art will readily recognize from the following discussion that alternative embodiments of the structures and methods illustrated herein may be employed without departing from the principles of the invention described herein.

### DETAILED DESCRIPTION

### Motivation

Computer implementations of deep neural networks (DNNs) commonly use floating-point arithmetic. As used herein, a deep neural network is a computer model that generates a set of outputs based on a set of inputs using a plurality of processing layers between the inputs and outputs. These processing layers may be “hidden” in the sense that the processing layers are not directly exposed during use, and represent arithmetic processes that together generate the set of outputs from the set of inputs. Individual nodes in these layers are typically connected by weights representing a weight of a value in a prior node that affects a current node. As an example, to process an image, the pixels of an image may be represented as an input layer. A subsequent layer may apply various filters, such as a convolutional filter, to a window of pixels in the input layer to generate values for that layer. This is often performed with floating-point arithmetic to increase precision in representing values within the network. However, low-cost and low-power computer processors (such as those used in internet-of-things devices) often do not provide support for floating-point arithmetic, and integer arithmetic must be used instead.

Further, while computer implementations of neural networks commonly use 32-bit arithmetic, low-power computer processors often run most efficiently (i.e. lowest power usage and/or highest throughput) using 8-bit arithmetic.

This presents a need for effective neural networks for use in lower-bit arithmetic and storage (e.g., 8-bit arithmetic and 8-bit storage) that is not well-addressed by existing frameworks.

### Design Constraints

When the goal is to get the best tradeoff of speed, energy-efficiency, and accuracy, the optimal DNN architecture (sometimes called a “topology” or “neural structure”) varies depending on the processing platform that it will be deployed on.

This disclosure relates to implementing neural network architectures on a reduced-bit architecture, which may be included reduced-bit (e.g., 8-bit) arithmetic and storage.

As one example architecture, a processing platform is a system-on-chip (SOC) that has multiple types of processing cores. Some of the cores on the SOC are general-purpose central processing unit (CPU) cores that support 8-, 16-, and 32-bit computations. But, these CPU cores are relatively slow and comparatively energy-intensive. However, the SOC also has specialized digital signal processing (DSP) cores that enable fast, energy-efficient, and highly-parallel computations. These DSP cores typically only support efficient computation of 8-bit signed integer computations. The network architecture discussed herein may be implemented on such DSP cores while rarely (or never) using the CPU cores.

The main data type supported in the DSP cores is the 8-bit signed integer.

Some processors support what is called “saturating arithmetic.” In saturating arithmetic, for 8-bit signed integers, if variables X and Y are of type signed int, the maximum value of X+Y is 127. For example, if X=120 and Y=120, a saturating addition of X+Y would give the result of 127. However, with non-saturating arithmetic, X+Y typically overflows such that the result of X+Y would be −16 (i.e. negative 16). The DNN architectures discussed herein are implemented with processors using non-saturating arithmetic. Thus, overflow happens when the result exceeds the maximum value or minimum value that can be represented by the number of bits on the register that are used to perform arithmetic operations.

However, to avoid generating incorrect numerical results, the arithmetic should not overflow. This is particularly challenging when using 8-bit storage and 8-bit arithmetic. For example, multiplying large two 8-bit numbers—e.g., 125 and 126 —the correct result is 15750, but the largest value representable in a signed 8-bit number is +127.

Division is an expensive arithmetic operation (requiring more computational cycles than multiplication or additions). Accordingly, effective use of an 8-bit architecture rarely or never uses division.

The bit-shift operator may be used. Bit-shift requires fewer computational cycles than division. For division by powers-of-two, the bit-shift operator can be used in place of division to produce the same results.

### Elementary Components of StarNet

A family of neural network architectures, generally termed “StarNet,” is disclosed to effectively implement neural networks on such reduced-bit architectures. In one embodiment, the components and processes described below may refer to or may be performed by an online system in communication with devices including reduced-bit architectures, such as internet-of-thing (IoT) devices.

To avoid overflows while performing 8-bit computations, StarNet applies the following techniques.

Neural networks commonly use convolution filters that each perform thousands of calculations (e.g. a 3×3×512 filter has 4068 elements and performs 4068 multiply-accumulate operations). The result of a 4068-element convolution will overflow with many possible input activations when computed using 8-bit arithmetic. Consider the case where the input activations consists of all ones and the filter (e.g., weights for combining prior layer values) consists of all ones (i.e. every element of the filter has a numerical value of one). The output of a convolution calculation in this example is the number 4068, which is much too large to be represented in 8-bit arithmetic and therefore would overflow and provide incorrect numerical results.

To effectively implement a neural network in reduced-bit architecture, the DNN is structured to have fewer elements per filter, such as 32 elements per filter. In one embodiment, the StarNet DNN architecture for 8-bit arithmetic and 8-bit storage has a maximum of 32 elements per filter.

Even when using a 32-element filter, 8-bit arithmetic can still overflow. For example, consider the case where the input activations consists of all ones. And, the filter consists of all fives (i.e. every element of the filter has a numerical value of five). In this case, the correct output of the convolution calculation is 160, but again the maximum representable value in an 8-bit signed integer is 127, so this overflows.

To avoid overflow, the network architecture may use various approaches to reduce the possible filter outputs within the range of the output values. The particular approach may vary, including within a given network model, based on the number of elements in the filter. In one implementation, linear quantization is used to bin floating-point values of filters and activations into a low-bit width integer representation. In one linear quantization scheme, the range of values of the linear bins is determined by analyzing the maximum and minimum numerical values that are observed in tensors of the neural network, looking at the dimensions of the filters, and then selecting maximum and minimum values for the bins such that the output cannot overflow.

In the case of a 32-element filter, input activations can be quantized to 2 bits plus the sign bit; we abbreviate this to (2+s). And, weights can be quantized to (1+s). So, the maximum value of an activation is 3 (which is the largest number representable in (2+s) arithmetic), and the maximum value of a weight is 1 (which is the largest number representable in (1+s) arithmetic). So, the largest possible output value is 32*3*1=96, which is smaller than 127 and therefore does not overflow during 8-bit arithmetic. Since values are stored in 8-bits in this example the storage of the activations and weights uses a subset of those 8 bits.

In the case of a 16-element filter, input activations are represented as (3+s), with a maximum value of 7, and weights are represented as (1+s), with a maximum value of 1. The maximum output value of this convolution is 16*7*1=112, which is less than 127 and therefore does not overflow.

In the case of an 8-element filter, input activations are represented as (2+s), with a maximum value of 3, and weights are represented as (2+s), with a maximum value of 3. The maximum output value of this convolution is 8*3*3=72, which is less than 127 and therefore does not overflow.

The 32-, 16-, and 8-element filters discussed so far are 1×1xChannels filters, where 32, 16, or 8 is the number of channels in the filter. Note that the number of channels in the input activations can be larger than the number of channels in a filter. This is accomplished using what are called group convolutions. Group convolutions have a hyperparameter called group-length. If the input activations have 1024 channels, and group-length is set to 32, then each filter will span a 32-channel subset of the 1024 input channels.

Convolutional neural networks commonly have some layers with filters of size 1×1×Channels and other layers with filters of size 3×3×Channels. In a 3×3 filter with a group-length of 1, there are 9 elements. A good representation of a 9-element convolution using (unsigned, non-saturating) 8-bit arithmetic is to represent weights as (2+s) and input activations as (2+s). In this configuration, the maximum output is 3*3*9=81.

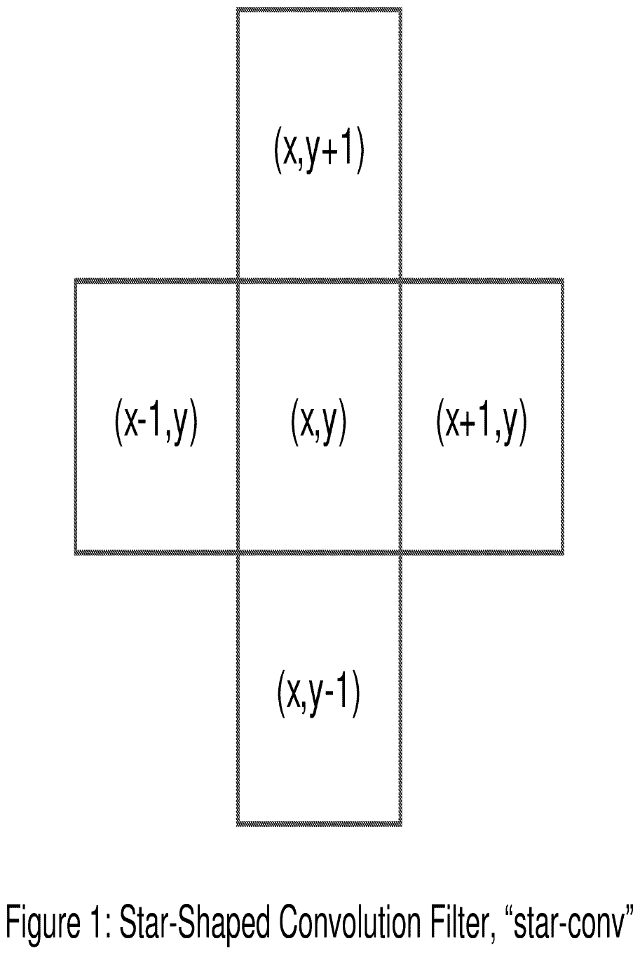

However, with the goal of minimizing the number of elements (and thus being able to represent filters and activations with more bits), the following is a way to perform a convolution with a 2D spatial resolution while using fewer elements. Rather than a 3×3 filter, the idea is to use a “star-shaped” filter. (See FIG. 1.) Here, with respect to a pixel at location (x,y), the filter has weights that correspond with (x,y) and also with the pixels to the immediate top, bottom, left, and right of (x,y). However, unlike a traditional 3×3 convolution, a star-shaped filter may not have weights or zero out weights that correspond with the upper-left, upper-right, lower-left, and lower-right diagonal elements with respect to location (x,y). Thus, in the example shown in FIG. 1, the star-shaped filter has only 5 elements. With only 5 elements, the weights can be represented as (3+s) and the activations can be represented as (2+s). However, the star-shaped filter can generally refer to non-rectangular filters in which only a subset of elements in the filter have non-zero values or are accounted for in the neural network structure. While the example shown in FIG. 1 illustrates a star-shaped filter with a single channel, in other embodiments, each position of the star-shaped filter may be associated with additional elements along the depth of the filter that correspond to one or more channels. Henceforth, this star-shaped filter will be known as “star-conv,” and 1×1×Channels filter will be known as “1×1-conv.”

Note that all of the aforementioned filters have a value of group-length that is greater than 1. When a series of convolution layers have a group-length of greater than 1, what several independent neural networks may be formed that do not share data for several layers in a row because subsets of channels are processed independently for several layers. This leads to a reduction in representational power. To address this, StarNet adopts the “shuffle” layer, which interleaves the ordering of channels to enable communication across what would otherwise be a collection of independent neural networks. For example, a shuffle layer may receive a set of input values that are arranged with respect to a plurality of channels. At the shuffle layer, the neural network structure may interleave the ordering of the channels to increase representational power.

### The Star-Shuffle Block

The StarNet family of DNN architectures uses a recurring block called the star-shuffle block. This block consists of the following ordering of neural network layers: {1×1-conv, relu, star-conv, relu, shuffle}.

The design of the star-shuffle block enables it to see a 2d spatial resolution (using star-conv), to mix information across nearby channels (using 1×1-conv with group-length of no more than 32), and to combine information across far-away channels (using the shuffle layer). All of this is accomplished while performing all computation using non-saturating signed 8-bit arithmetic.

### Quantization Mechanism

To quantize a number from a generic 8-bit (7+s) representation to a lower-bit representation, e.g. (2+s), bins are generated as described in the section “Quantization Binning Process” below. The quantization method has a preprocessing step and a runtime step, which are described in the following.

The preprocessing step generates a set of bins that are used during the runtime step of quantization. This set of bins can be described using “quantization parameters,” which describe the bins. Each layer in the neural network has two sets of quantization parameters: “activation quantization parameters” which describe the binning of input and output values of the layer, and “layer quantization parameters” which describe the binning of the parameters of the layer itself. The parameters of a particular layer may refer to the weights of filters associated with the particular layer.

Each set of bins has two processes associated with it. One is called the “quantization” process, where generic 8-bit (7+s) representations are processed into a lower-bit (2+s) representation. The other process, called the “dequantization” process, is the inverse, where the lower-bit (2+s) representation is transformed back into the 8-bit (7+s) representations. Each binning process describes its own mechanism for quantization and dequantization.

To finalize the preprocessing step, the layer parameters are binned according to the quantization process using the layer quantization parameters. These are referred to as “quantized layer parameters.” For example, a filter with a set of trained weights V_{R,weights} may be quantized using the equation:

$${V}_{Q , weights} = \frac{{V}_{R , weights}}{{A}_{w e i g h t s}} - {B}_{weights}$$

where A_{weights} and B_{weights} are the layer quantization parameters, and V_{Q,weights} are the quantized layer parameters.

During runtime, each layer first applies the quantization binning process using the activation quantization parameters to its input if the input is not quantized. For example, a layer with a set of input values V_{R,input} may be quantized to a quantized input using the equation:

$${V}_{Q , input} = \frac{{v}_{R , input}}{{A}_{input}} - {B}_{input}$$

where Aᵢₙₚᵤₜ and Bᵢₙₚᵤₜ are the activation quantization parameters.

The parameters associated with this quantization binning process are attached to the input, and the input is fed into the layer. This layer then applies its standard operation using the quantized layer parameters. For example, using the example above, a quantized output may be generated by the equation:

Quantized Output=f_{V}_{_{Qweights}}(V_{Q,input})

where f_{VQ,weights}(·) denotes an operation on the quantized input using the quantized layer parameters. For example, this may be a dot product between the filter and the quantized input.

Next, the layer applies the dequantization process using the layer quantization parameters. For example, the quantized output may first be dequantized to an output:

$${V}_{R , output} = {A}_{w eights} \cdot ( Quantized Output + {B}_{w eights} ) .$$

Then, the dequantization process uses the activation quantization parameters that are attached to the original input to dequantize the output. For example, the dequantization of the output may be given by:

$$Dequantized Output = {A}_{input} \cdot ( {V}_{R , output} + {B}_{input} ) .$$

### Quantization Binning Process

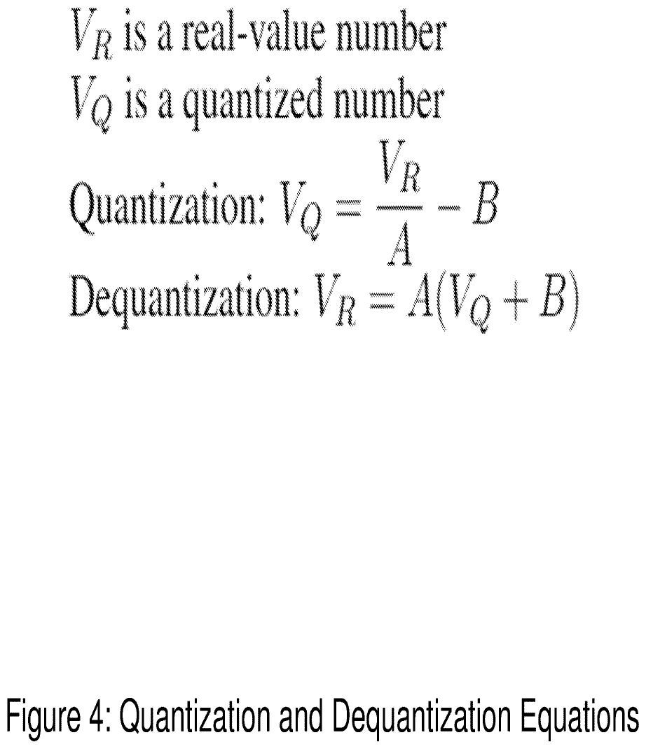

This quantization binning approach creates a set of bins implicitly based on a quantization equation and its corresponding dequantization equation, which are described by two parameters, “A” and “B” as shown in FIG. 4.

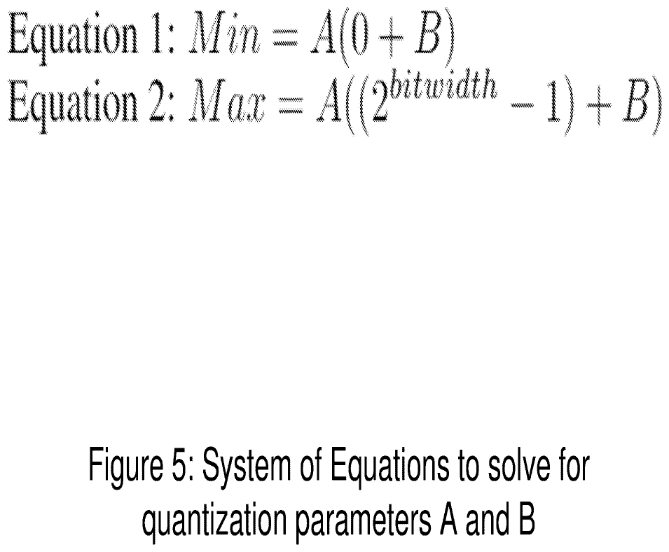

To solve for the activation quantization parameters, a dataset is passed through the neural network one example at a time and a set of output values is collected for each layer in the neural network. For each set of output values associated with a layer, the minimum and maximum output values are identified. The minimum and maximum output values are plugged into the dequantization equation, along with the selected bit-width, to produce the system of equations pictured in FIG. 5. This system of equations is solved to find the activation quantization parameters associated with each layer.

This same process occurs with the parameters of the StarNet instance being quantized. Each layer has its minimum and maximum parameter passed into the quantization equation, along with the selected bit-width, to produce the system of equations pictured in FIG. 5. This system of equations is solved to find the layer quantization parameters associated with each layer.

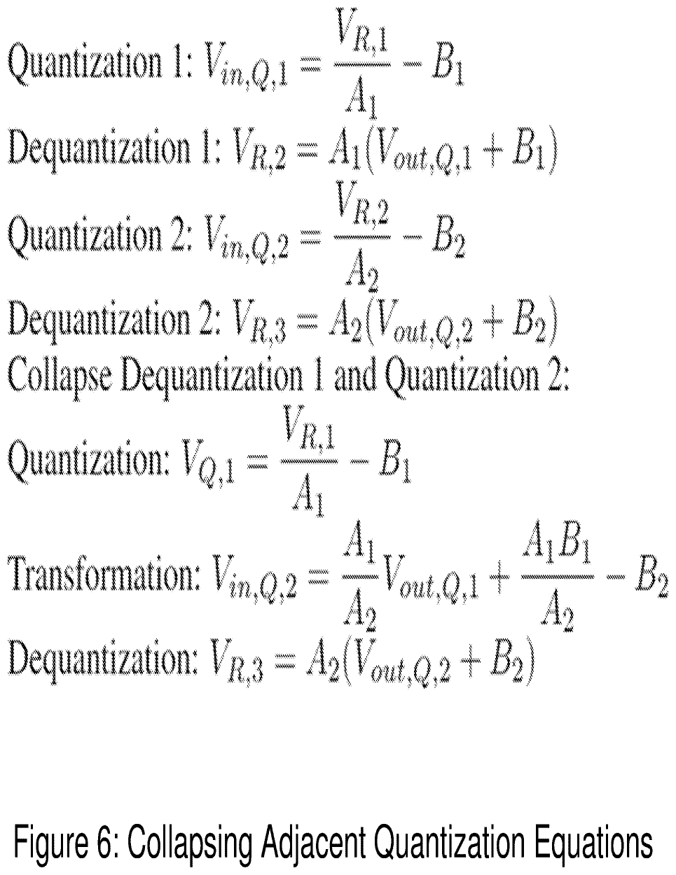

Optimizations can be applied to the quantization method above. In particular, we describe the “quantization collapsing” mechanism by which quantization equations for adjacent layers and activations can be collapsed into a single equation. The mathematical transformation is shown in FIG. 6, where the quantization operation of adjacent bins is collapsed, and the corresponding dequantization operations are collapsed as well. This reduces the number of operations between each quantization and dequantization by a factor of two. However, we also can leave out both of them, using only the initial quantization equation and final dequantization equation.

In various embodiments, by using maximum values that correspond to the values representable by quantized representations (e.g., a maximum value of 7 for (3+) representation), calculations such as division can be performed more often with a bit-shift operator, reducing computational complexity and time in the reduced-bit representation and execution.

### Starnet Neural Network Family

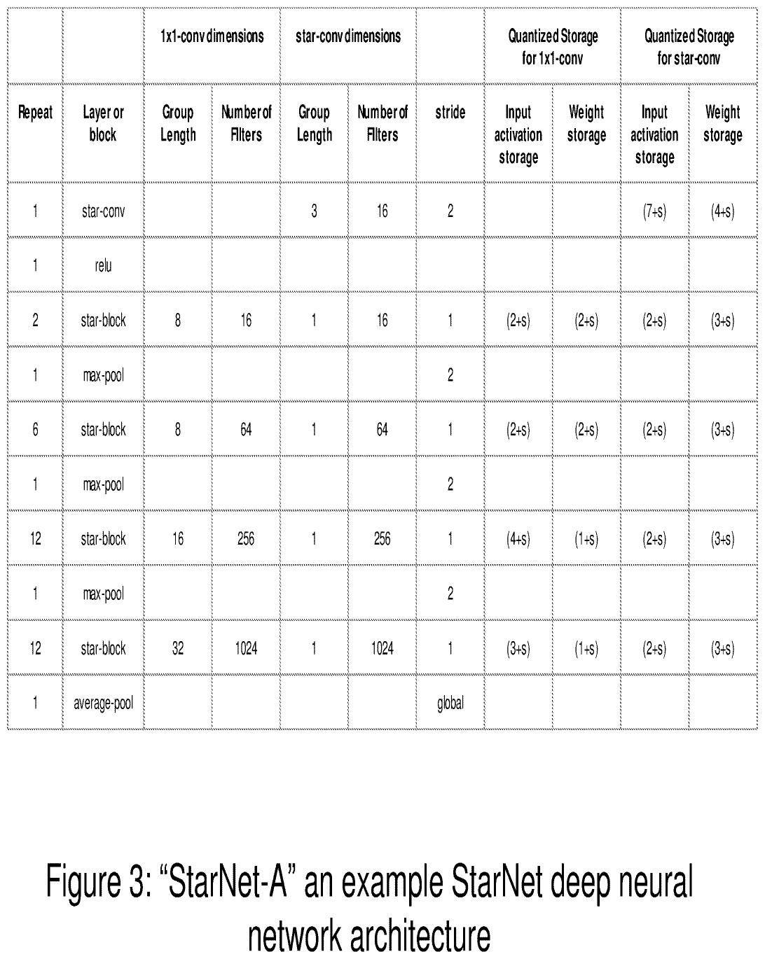

Various DNNs can be formed using the star-block. As used herein, a StarNet is a DNN containing one or more star-block modules. In the following, one example implementation of a StarNet neural network architecture is described. In this example, called “StarNet-A,” the DNN is tasked with ingesting an RGB image and classifying the image into one of 1024 categories. See FIG. 3 for a summary of the StarNet-A DNN architecture that is described in the following. With the exception of the first convolution layer in StarNet-A, all layers of StarNet-A can be implemented using only 8-bit arithmetic and 8-bit storage.

The first layer of StarNet-A is a star-conv layer, which is applied to an input image. While the inputs to most layers can be quantized without losing accuracy, one exception to this is that quantizing the input image does damage accuracy. Therefore, in the first layer is computed with 8-bit inputs, 16-bit arithmetic, and 16-bit temporary storage for activations. In one implementation, this first layer is computed on the CPU of an IOT system-on-chip (SOC), while all subsequent layers of StarNet-A are computed on an energy-efficient accelerator that is on the same SOC. A rectified linear unit (relu) follows the first star-conv layer, and the first star-conv layer has a stride of 2.

Next, StarNet-A has a series of 2 star-block modules, the details of which are described in FIG. 3. These star-block modules are followed by downsampling operation which is implemented using max-pooling with a stride of 2.

After that, there are 6 more star-block modules, a max-pool, 12 more star-block modules, a max-pool, and finally 12 more star-block modules. After each downsampling operation (e.g. max-pool), the number of filters is increased.

The first series of 2 star-block modules and the next series of 6 star-block modules use a group length of 8 for their 1×1-conv filters. To avoid overflow, the input activations and the weights for the 1×1-convs are represented using (2+s) bits, and these bits are contained in 128-bit outputs. The rationale for using (2+s) is: the maximum value of a (2+s) number is 3, the group length is 8, so the maximum output value is 3*3*8=72, which is smaller than 127 and therefore does not overflow when the output value is represented in 8-bits.

The next two series of 12 star-block modules have a group length of 16 and 32, respectively. Care is taken to develop a quantization scheme for these modules that does not overflow when using 8-bit storage and 8-bit arithmetic. The particular quantization scheme is shown in FIG. 3.

After the final star-block module, global average pooling is applied. This has the effect of reducing a H×W×Channels tensor of output activations down to a 1×1×Channels vector of output activations. In StarNet-A, the final star-block module has 1024 output channels, so the final output vector (after applying global average pooling) is a 1024-dimensional vector.

When running StarNet-A on an image, the largest of the 1024 output channels is the category that StarNet-A predicts is contained in the image.

In an other implementation, the final layers of StarNet-A can be configured to produce an activation grid that represents a semantic segmentation mask of a whole image.

In an other implementation, the input to StarNet-A includes a depth map.

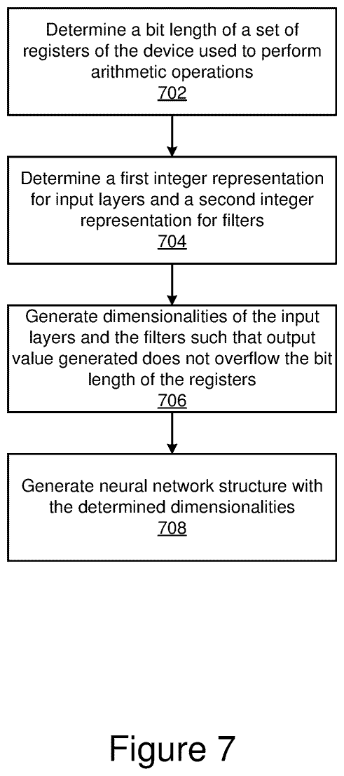

FIG. 7 illustrates an example process for generating a neural network structure including input layers and filters, according to one embodiment. The online system determines 702 a bit length of a set of registers of the device used to perform arithmetic operations. For example, the registers may have an 8-bit architecture. The online system determines 704 a first integer representation for one or more input layers of the neural network structure and a second integer representation for one or more filters. The first integer representation may be associated with a first range of integer values and the second integer representation may be associated with a second range of integer values. Thus, each element in the input layers when quantized, may have a minimum to maximum range of integer values defined by the first integer representation. Similarly, each element in the filters when quantized, may have a minimum to maximum range of integer values defined by the second integer representation.

The online system generates 706 dimensionalities of the one or more input layers and the one or more filters. The dimensionalities are determined such that an output value generated by combining elements of an input layer as maximum values of the first integer representation with elements of a corresponding filter as maximum values of the second integer representation does not overflow the bit length of the set of registers. The online system generates 708 the neural network structure with the determined dimensionalities.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### Terminology

“Output Activation”: The output data produced by a layer of a deep neural network.
“Input Activation”: The input data provided to a layer of a deep neural network.
“Weight”: A learned parameter in a DNN.
“Filter”: A collection of weights organized in a specific pattern (e.g. a 3×3×256 convolution filter).
“Group-Length”: The number of channels in a convolution filter.

What is claimed is:

1. A method of generating a neural network structure including one or more input layers each associated with one or more filters, the method comprising:
determining, for an architecture of a device, a bit length of a set of registers of the device used to perform arithmetic operations;
determining a first integer representation for the one or more input layers and a second integer representation for the one or more filters, the first integer representation associated with a first range of integer values and the second integer representation associated with a second range of integer values;
generating dimensionalities of the one or more input layers and the one or more filters, the dimensionalities determined such that an output value generated by combining elements of an input layer as maximum values of the first integer representation with elements of a corresponding filter as maximum values of the second integer representation does not overflow the bit length of the registers; and
generating the neural network structure with the determined dimensionalities, wherein for at least one layer which forms the neural network structure, an activation is quantized using an activation parameter for the at least one layer and a weight is quantized using a layer parameter for the at least one layer.

2. The method of claim 1, wherein generating the dimensionalities comprises generating the one or more filters for a corresponding input layer as star-shaped filters.

3. The method of claim 1, further comprising:
receiving a set of input values corresponding to the elements of an input layer in the one or more input layers, and a set of weights corresponding to the elements of a filter in the one or more filters with the generated dimensionalities;
quantizing the set of input values by assigning each input value to a corresponding integer value in the first integer representation;
quantizing the set of weights by assigning each weight to a corresponding integer value in the second integer representation; and
combining the set of input values and the set of weights to generate a quantized output.

4. The method of claim 3, wherein the neural network structure includes a shuffle layer placed after the corresponding input layer, the method further comprising:
receiving another set of input values at the shuffle layer, wherein the another set of input values are arranged with respect to a plurality of channels; and
interleaving ordering of the plurality of channels at the shuffle layer.

5. The method of claim 3, wherein quantizing the set of input values comprises:
obtaining a dataset including a plurality of data instances;
propagating the plurality of data instances through the neural network structure to obtain input values at the input layer;
identifying a lower bound value and an upper bound value from the input values obtained at the input layer; and
dividing a range between the lower bound value and the upper bound value into a plurality of bins each assigned to a corresponding integer value in the first integer representation.

6. The method of claim 3, wherein quantizing the set of weights comprises:
identifying a lower bound value and an upper bound value from the set of weights; and
dividing a range between the lower bound value and the upper bound value into a plurality of bins each assigned to a corresponding integer value in the second integer representation.

7. The method of claim 1, wherein the bit length of the set of registers are 8 bits, and the arithmetic operations are performed using 8-bit arithmetic.

8. A non-transitory computer-readable medium containing instructions for execution on a processor, the instructions comprising:
determining, for an architecture of a device, a bit length of a set of registers of the device used to perform arithmetic operations;
determining a first integer representation for the one or more input layers and a second integer representation for the one or more filters, the first integer representation associated with a first range of integer values and the second integer representation associated with a second range of integer values;
generating dimensionalities of the one or more input layers and the one or more filters, the dimensionalities determined such that an output value generated by combining elements of an input layer as maximum values of the first integer representation with elements of a corresponding filter as maximum values of the second integer representation does not overflow the bit length of the registers; and
generating the neural network structure with the determined dimensionalities, wherein for at least one layer which forms the neural network structure, an activation is quantized using an activation parameter for the at least one layer and a weight is quantized using a layer parameter for the at least one layer.

9. The non-transitory computer-readable medium of claim 8, wherein generating the dimensionalities comprises generating the one or more filters for a corresponding input layer as star-shaped filters.

10. The non-transitory computer-readable medium of claim 8, the instructions further comprising:
receiving a set of input values corresponding to the elements of an input layer in the one or more input layers, and a set of weights corresponding to the elements of a filter in the one or more filters with the generated dimensionalities;
quantizing the set of input values by assigning each input value to a corresponding integer value in the first integer representation;
quantizing the set of weights by assigning each weight to a corresponding integer value in the second integer representation; and
combining the set of input values and the set of weights to generate a quantized output.

11. The non-transitory computer-readable medium of claim 10, wherein the neural network structure includes a shuffle layer placed after the corresponding input layer, the instructions further comprising:
receiving another set of input values at the shuffle layer, wherein the another set of input values are arranged with respect to a plurality of channels; and
interleaving ordering of the plurality of channels at the shuffle layer.

12. The non-transitory computer-readable medium of claim 10, wherein quantizing the set of input values comprises:
obtaining a dataset including a plurality of data instances;
propagating the plurality of data instances through the neural network structure to obtain input values at the input layer;
identifying a lower bound value and an upper bound value from the input values obtained at the input layer; and
dividing a range between the lower bound value and the upper bound value into a plurality of bins each assigned to a corresponding integer value in the first integer representation.

13. The non-transitory computer-readable medium of claim 10, wherein quantizing the set of weights comprises:
identifying a lower bound value and an upper bound value from the set of weights; and
dividing a range between the lower bound value and the upper bound value into a plurality of bins each assigned to a corresponding integer value in the second integer representation.

14. The non-transitory computer-readable medium of claim 8, wherein the bit length of the set of registers are 8 bits, and the arithmetic operations are performed using 8-bit arithmetic.

15. A system comprising:
a processor configured to execute instructions;
a computer-readable medium containing instructions for execution on the processor, the instructions causing the processor to perform steps of:
determining, for an architecture of a device, a bit length of a set of registers of the device used to perform arithmetic operations;
determining a first integer representation for the one or more input layers and a second integer representation for the one or more filters, the first integer representation associated with a first range of integer values and the second integer representation associated with a second range of integer values;
generating dimensionalities of the one or more input layers and the one or more filters, the dimensionalities determined such that an output value generated by combining elements of an input layer as maximum values of the first integer representation with elements of a corresponding filter as maximum values of the second integer representation does not overflow the bit length of the registers; and
generating the neural network structure with the determined dimensionalities, wherein for at least one layer which forms the neural network structure, an activation is quantized using an activation parameter for the at least one layer and a weight is quantized using a layer parameter for the at least one layer.

16. The system of claim 15, wherein generating the dimensionalities comprises generating the one or more filters for a corresponding input layer as star-shaped filters.

17. The system of claim 15, the instructions further comprising:
receiving a set of input values corresponding to the elements of an input layer in the one or more input layers, and a set of weights corresponding to the elements of a filter in the one or more filters with the generated dimensionalities;
quantizing the set of input values by assigning each input value to a corresponding integer value in the first integer representation;
quantizing the set of weights by assigning each weight to a corresponding integer value in the second integer representation; and
combining the set of input values and the set of weights to generate a quantized output.

18. The system of claim 17, wherein the neural network structure includes a shuffle layer placed after the corresponding input layer, the instructions further comprising:
receiving another set of input values at the shuffle layer, wherein the another set of input values are arranged with respect to a plurality of channels; and
interleaving ordering of the plurality of channels at the shuffle layer.

19. The system of claim 17, wherein quantizing the set of input values comprises:
obtaining a dataset including a plurality of data instances;
propagating the plurality of data instances through the neural network structure to obtain input values at the input layer;
identifying a lower bound value and an upper bound value from the input values obtained at the input layer; and
dividing a range between the lower bound value and the upper bound value into a plurality of bins each assigned to a corresponding integer value in the first integer representation.

20. The system of claim 15, wherein the bit length of the set of registers are 8 bits, and the arithmetic operations are performed using 8-bit arithmetic.
